(19) United States
(12) Patent Application Publication
(10) Pub. No.: US 2013/0229083 A1
(43) Pub. Date: Sep. 5, 2013

(54) Structure for Brushless Motors

(71) Applicant: HSIU-MEI CHANG, New Taipei City (TW)

(72) Inventor: HSIU-MEI CHANG, New Taipei City (TW)

(21) Appl. No.: 13/410,293

(22) Filed: Mar. 2, 2012

(51) Int. Cl. H02K 21/22; H02K 1/28

(52) U.S. Cl. 310/156.21; 310/156.38; 310/156.08

(57) ABSTRACT

An improved structure for brushless motors comprises a stationary part and a rotary or movable part mounted relative to the stationary part. The rotary part includes a frame and a plurality of magnets disposed, one after another, along one surface of the frame and attached to the surface of the frame adjacent to the stationary part, wherein each of the magnets has a curved surface so as to define a series of gaps between the curved surfaces of the magnets and the surface of the frame of the rotary or movable part. With the present invention, the airgap between the stationary part and rotary or movable part would be more uniform, and the motor can be manufactured more easily. Also, when running the motor, cogging or no-current torque can be reduced or eliminated, so that the motor can be operated more smoothly.

### (a) TECHNICAL FIELD OF THE INVENTION

The present invention relates to an improved structure for brushless motors, and more particularly to an improved structure for brushless motors, which contains a uniform airgap, and can be operated smoothly and manufactured easily.

### (b) DESCRIPTION OF THE PRIOR ART

In conventional brushless motors, since the airgap between the rotor and the stator is uneven, cogging or no-current torque would become more apparent in running the motor. Thus, those motors usually cannot be started or operated smoothly and would have significant vibration during operation, especially when they are employed in slower-running applications. Furthermore, since the magnetic flux distribution is not uniform in the airgap, the magnetic-field sensor mounted on the stator cannot measure the magnetic intensity appropriately, thereby causing more troubles in running the motor.

Thus, there is a need for providing an improved structure for brushless motors, which is easy to operate and manufacture, and has a uniform airgap.

### SUMMARY OF THE INVENTION

The primary object of the present invention is to provide an improved structure for brushless motors, which contains a uniform airgap, and can be operated smoothly and manufactured easily.

To achieve the above object, a first embodiment of the improved structure for brushless motors is provided, which comprises a stationary part and a rotary part mounted outside of the stationary part and turning about the stationary part. The rotary part includes a frame and a plurality of magnets disposed, one after another, along an inner surface of the frame and attached to the inner surface adjacent to the stationary part, wherein each of the magnets has a curved surface so as to define a series of gaps between the curved surfaces of the magnets and the inner surface of the frame of the rotary part. The magnets are arranged, one after another, along the inner surface of the frame to form a ring of magnets, wherein the polarities of any two neighboring magnets are different. Since each magnet is configured with a curved surface adjacent to the inner surface of the frame, and the airgap between the magnets and the stationary part is uniform, the magnetic flux distribution in the airgap would be more uniform or sinusoidal. Thus, when running the motor, cogging or no-current torque can be reduced or eliminated, so that the motor can be operated more smoothly.

To achieve the above object, a second embodiment of the improved structure for brushless motors is further provided, which comprises a stationary part and a rotary part mounted inside of the stationary part and turning about the stationary part. The rotary part includes a frame and a plurality of magnets disposed, one after another, along an outer surface of the frame and attached to the outer surface adjacent to the stationary part, wherein each of the magnets has a curved surface so as to define a series of gaps between the curved surfaces of the magnets and the outer surface of the frame of the rotary part. With this embodiment, when running the motor, cogging or no-current torque can be reduced or eliminated, so that the motor can be operated more smoothly.

To achieve the above object, a third embodiment of the improved structure for brushless motors is still further provided, which comprises a stationary part and a movable part mounted at one side of the stationary part and linearly moving relative to the stationary part. The movable part includes a frame and a plurality of magnets disposed, one after another, along one surface of the frame and attached to the surface of the frame adjacent to the stationary part, wherein each of the magnets has a curved surface so as to define a series of gaps between the curved surfaces of the magnets and the surface of the frame of the movable part. With this embodiment, when running the motor, cogging or no-current torque can be reduced or eliminated, so that the motor can be operated more smoothly.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional assembled view of a first embodiment of the present invention.

FIG. 1A is an enlarged 3-dimensional view, which partially shows the first embodiment.

FIG. 2 is an exploded view of the first embodiment.

FIG. 3 is a schematic view, which shows an operation of the first embodiment.

FIG. 3A is an enlarged plan view, which partially show the first embodiment.

FIG. 4 is a schematic view, which partially shows an operation of the first embodiment.

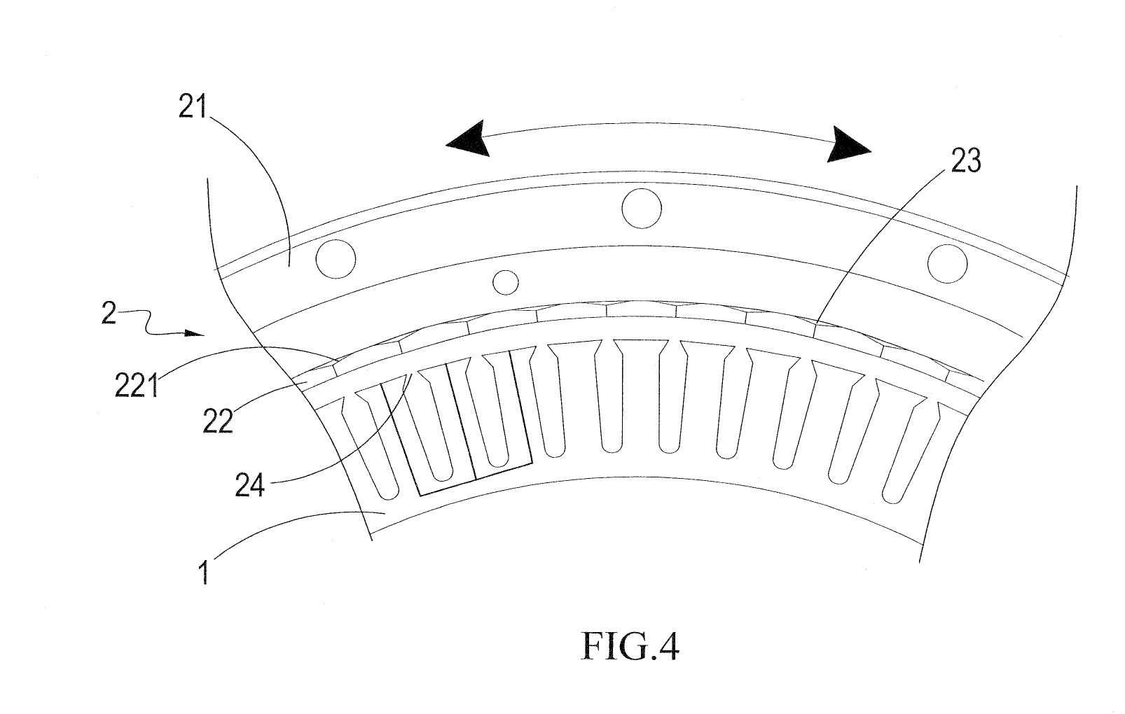

FIG. 5 is a partially enlarged plan view of a second embodiment of the present invention.

FIG. 6 is a schematic plan view of the second embodiment.

FIG. 7 is a partially enlarged plan view of a third embodiment of the present invention.

### DETAILED DESCRIPTION OF THE PREFERRED EMBODIMENTS

To allow the features and advantages of the present invention to be fully understood, various embodiments with reference to the accompanying drawings will be illustrated in the following.

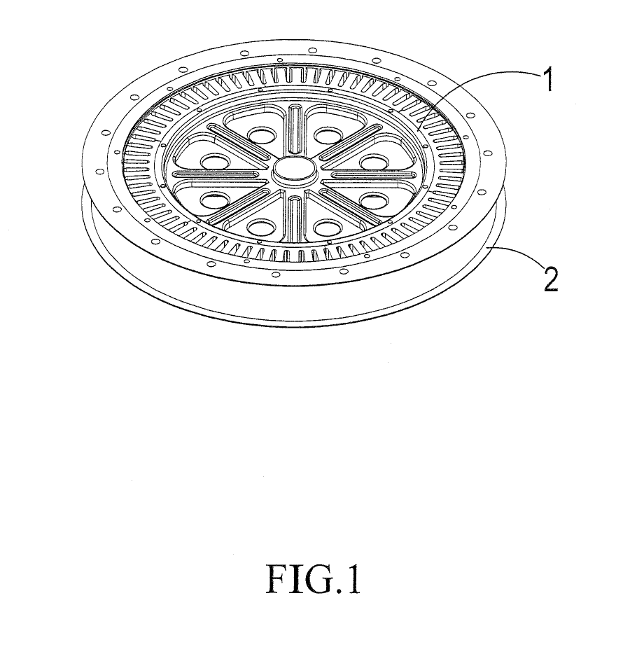

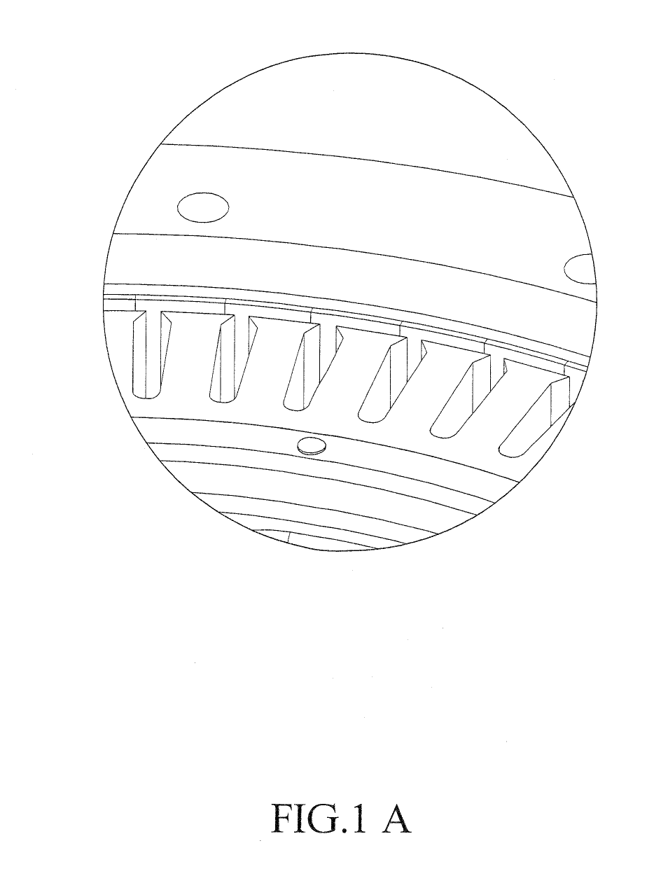

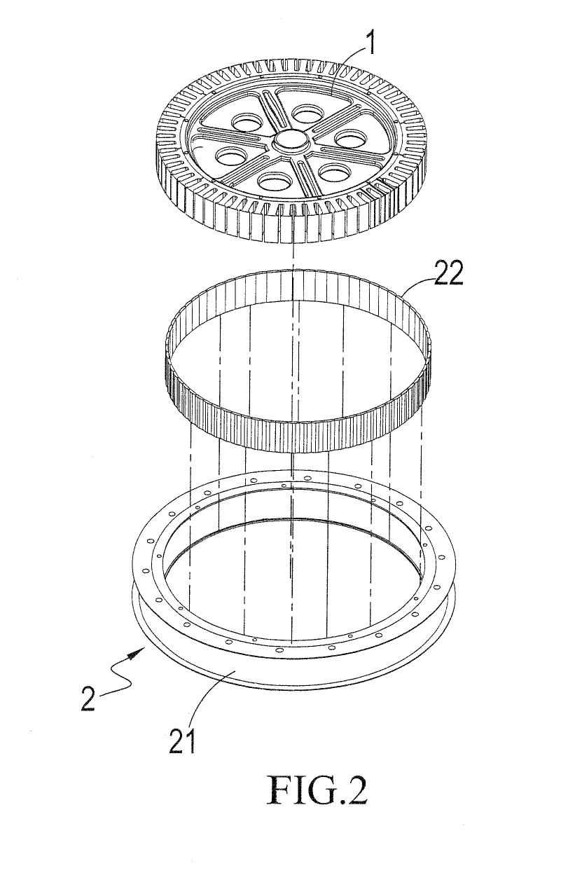

Referring to FIGS. 1, 1A, 2, 3, and 3A, a first embodiment of the present invention concerning an improved structure for brushless motors is disclosed, which comprises a stationary part 1 and a rotary part 2 mounted outside of the stationary part 1 and turning about the stationary part 1. The rotary part 2 includes a frame 21 and a plurality of magnets 22 disposed, one after another, along an inner surface of the frame 21 and attached to the inner surface, adjacent to the stationary part 1, by means of tight insertion or glue. Each of the magnets 22 has a first curved surface 221 and a second curved surface opposite to the first curved surface 221, whereby a series of gaps 23 can be defined between the first curved surfaces 221 of the magnets 22 and the inner surface of the frame 21, while a uniform airgap 24 can be defined between the second curved surfaces of the magnets 22 and the stationary part 1.

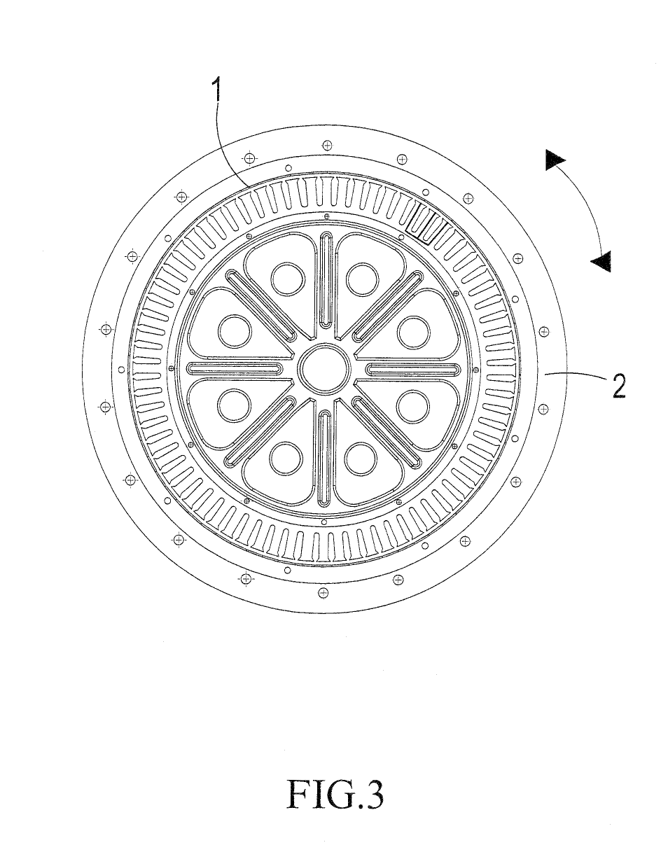

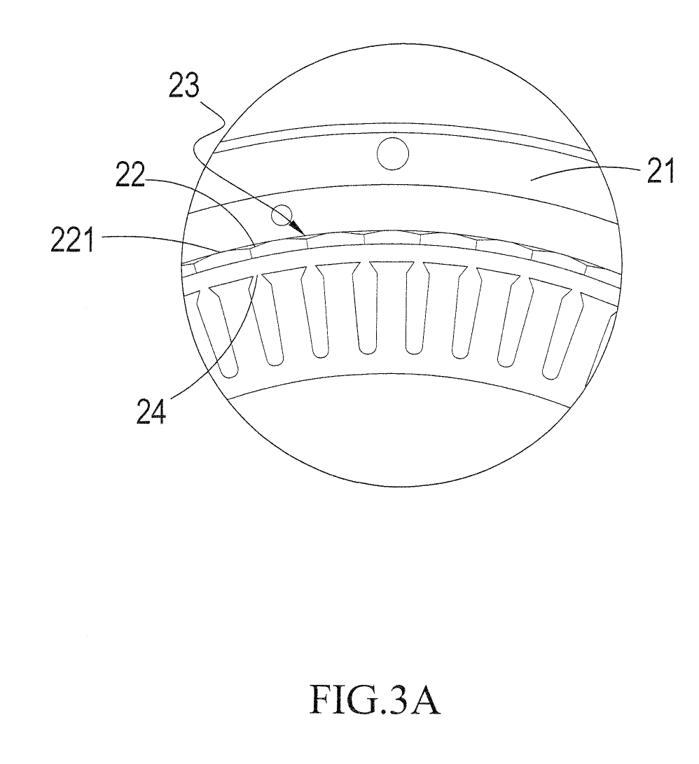

In more detail, as shown in FIG. 3, 3A and 4, the magnets 22 are arranged, one after another, along the inner surface of the frame 21 to form a ring of magnets, wherein the polarities of any two neighboring magnets are different. Since each magnet 22 is configured with the first curved surface 221 adjacent to the inner surface of the frame 21, and the airgap 24 between the magnets 22 and the stationary part 1 is uniform, the magnetic flux distribution in the airgap 24 would be more uniform or sinusoidal. Thus, when running the motor of the present invention, cogging or no-current torque can be reduced or eliminated, so that the motor can be operated more smoothly. Furthermore, a magnetic-field sensor or a Hall-effect sensor (not shown) of the motor can measure the magnetic intensity more appropriately, thereby facilitating the operation of the motor. Still furthermore, the series of irregular gaps 23 may facilitate the magnets 22 to be attached to the frame 21 of the rotary part 2, either by tight insertion or glue, so that the magnets 22 can be installed on the rotary part 2 more easily. Since the brushless motor of the present invention is simple in structure, easy to manufacture, and stable in operation, it can be applied in electric motorcycles, electric bikes, wind turbines, and other devices required for providing an output of high torque.

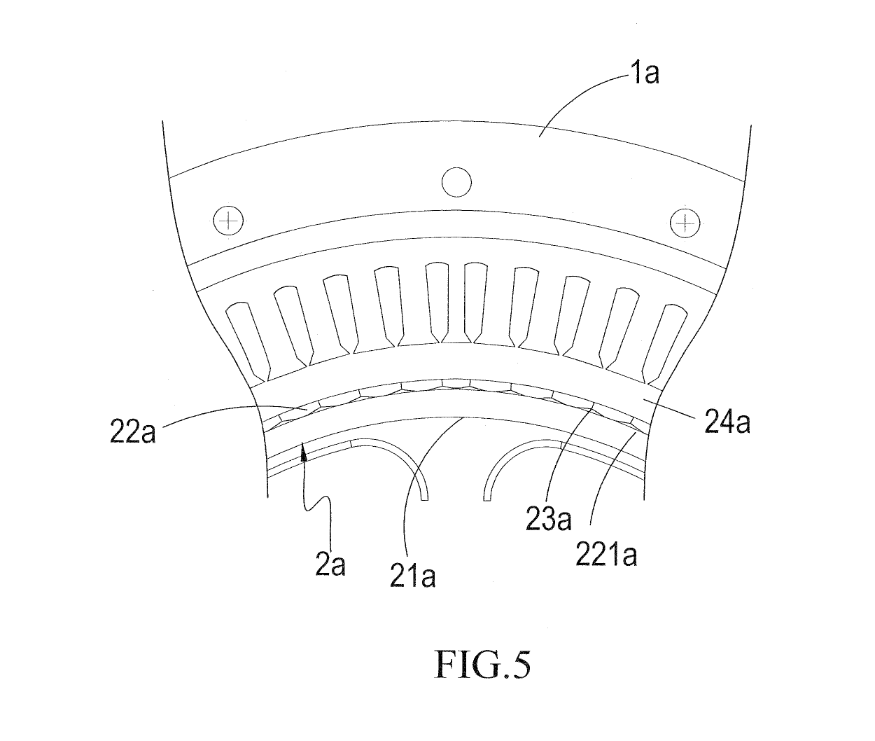

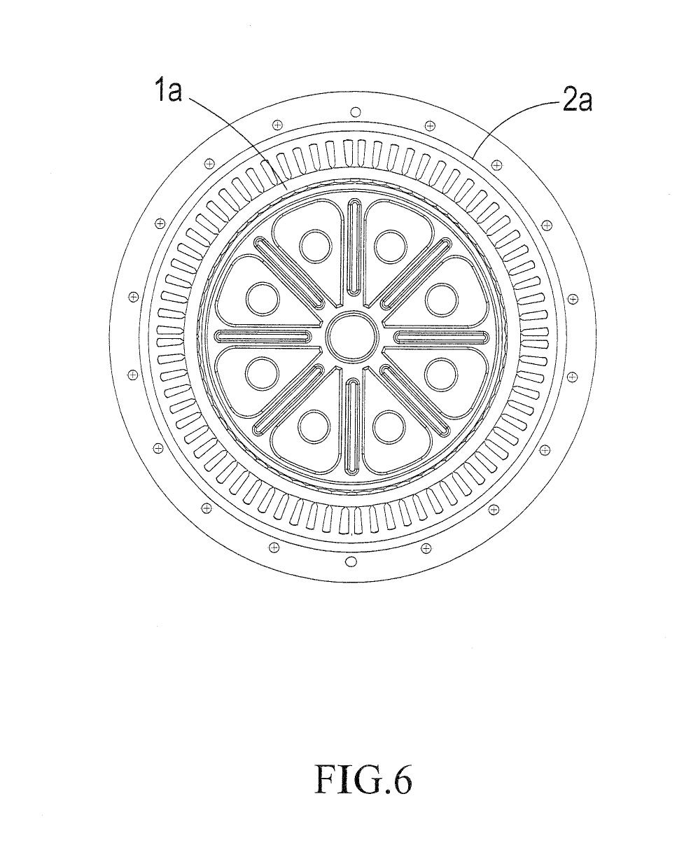

Turning now to FIGS. 5 and 6, a second embodiment of the present invention is disclosed, which comprises a stationary part 1a and a rotary part 2a mounted inside of the stationary part 1a and turning about the stationary part 1a. The rotary part 2a includes a frame 21a and a plurality of magnets 22a disposed, on after another, along an outer surface of the frame 21a and attached to the outer surface, adjacent to the stationary part 1a, by means of tight insertion or glue. Each of the magnets 22a has a first curved surface 221a and a second curved surface opposite to the first curved surface 221a, whereby a series of gaps 23a can be defined between the first curved surfaces 221a of the magnets 22a and the outer surface of the frame 21a, while a uniform airgap 24a can be defined between the second curved surfaces of the magnets 22a and the stationary part 1a. In more detail, the magnets 22a are arranged, on after another, along the outer surface of the frame 21a to form a ring of magnets 22a, wherein the polarities of any two neighboring magnets are different. This embodiment employs the same principles as the first embodiment, and thus has the same advantages, including simple structure, easy manufacturing, and stability in operation.

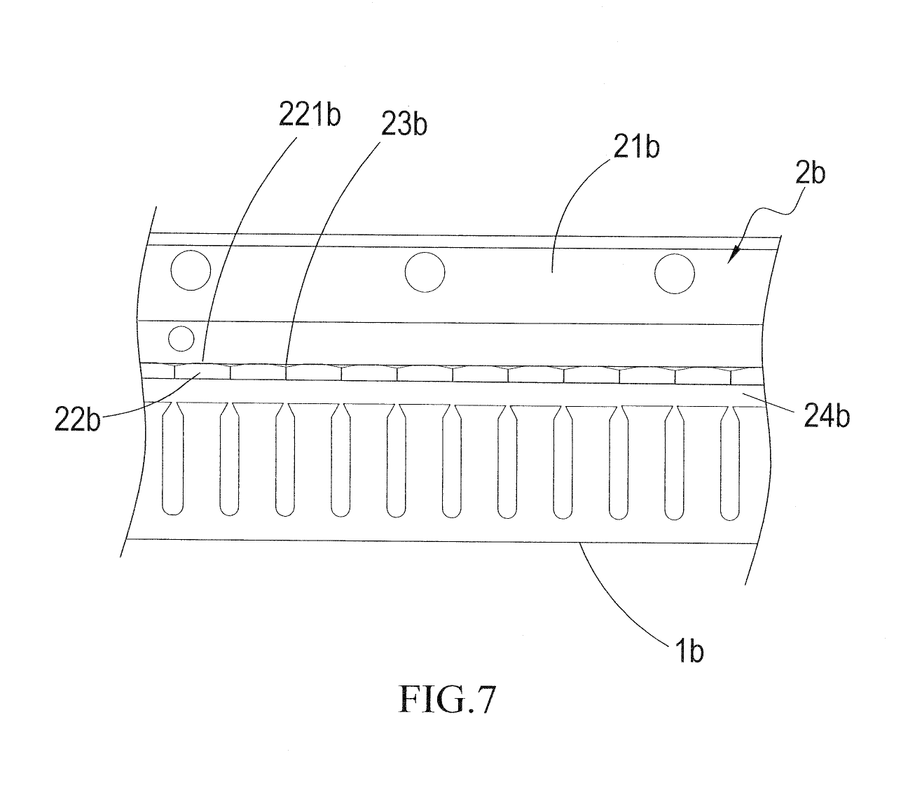

Referring to FIG. 7, a third embodiment of the present invention is disclosed, which comprises a stationary part 1b and a movable part 2b mounted at one side of the stationary part 1b and linearly moving relative to the stationary part 1b. The movable part 2b includes a frame 21b and a plurality of magnets 22b disposed, one after another, along one surface of the frame 21b and attached to the surface of the frame 21b, adjacent to the stationary part 1b, by means of tight insertion or glue. Each of the magnets 22b has a first curved surface 221b and a second curved surface opposite to the first curved surface 221b, whereby a series of gaps 23b can be defined between the first curved surfaces 221b of the magnets 22b and the surface of the frame 21b, while a uniform airgap 24b can be defined between the second curved surfaces of the magnets 22b and the stationary part 1b. In more detail, the magnets 22b are arranged, one after another, along the surface of the frame 21b to form a series of magnets 22b, wherein the polarities of any two neighboring magnets are different. This embodiment employs the same principles as the first embodiment, and thus has the same advantages, including simple structure, easy manufacturing, and stability in operation.

As a summary, the present invention has the following advantages as compared with the prior art:

1. Since the magnets are each configured with a first curved surface adjacent to one surface of the frame of the rotary or movable part, and the airgap between the magnets and the stationary part is more uniform, the magnetic flux distribution in the airgap would be more uniform or sinusoidal. Thus, when running the motor, cogging or no-current torque can be reduced or eliminated, so that the motor can be operated more smoothly.

2. Since the airgap between the magnets and the stationary part is more uniform, the magnetic-field sensor of the motor can measure the magnetic intensity more appropriately, thereby facilitating the operation of the motor.

3. The series of irregular gaps between the magnets and the frame of the rotary or movable part allows the magnets to be attached to the frame of the rotary or movable part more easily, either by tight insertion or glue.

4. The brushless motor according to the present invention is simple in structure, easy to manufacture, and stable in operation, it can be applied in electric motorcycles, electric bikes, wind turbines, and other devices required for providing an output of high torque.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An improved structure for brushless motors, which comprises a stationary part and a rotary part mounted outside of said stationary part and turning about said stationary part, said rotary part including:
a frame; and
a plurality of magnets disposed, one after another, along an inner surface of said frame and attached to said inner surface adjacent to said stationary part, wherein each of said magnets has a curved surface so as to define a series of gaps between said curved surfaces of said magnets and said inner surface of said frame of said rotary part.

2. An improved structure for brushless motors as claimed in claim 1, wherein said magnets are attached to said frame by means of tight insertion.

3. An improved structure for brushless motors as claimed in claim 1, wherein said magnets are attached to said frame by means of glue.

4. An improved structure for brushless motors, which comprises a stationary part and a rotary part mounted inside of said stationary part and turning about said stationary part, said rotary part including:
a frame; and
a plurality of magnets disposed, one after another, along an outer surface of said frame and attached to said outer surface adjacent to said stationary part, wherein each of said magnets has a curved surface so as to define a series of gaps between said curved surfaces of said magnets and said outer surface of said frame of said rotary part.

5. An improved structure for brushless motors as claimed in claim 4, wherein said magnets are attached to said frame by means of tight insertion.

6. An improved structure for brushless motors as claimed in claim 4, wherein said magnets are attached to said frame by means of glue.

7. An improved structure for brushless motors, which comprises a stationary part and a movable part mounted at one side of said stationary part and linearly moving relative to said stationary part, said movable part including:
a frame; and
a plurality of magnets disposed, one after another, along one surface of said frame and attached to said surface of said frame adjacent to said stationary part, wherein each of said magnets has a curved surface so as to define a series of gaps between said curved surfaces of said magnets and said surface of said frame of said movable part.

8. An improved structure for brushless motors as claimed in claim 7, wherein said magnets are attached to said frame by means of tight insertion.

9. An improved structure for brushless motors as claimed in claim 7, wherein said magnets are attached to said frame by means of glue.
